(19) United States
(12) Patent Application Publication
(10) Pub. No.: US 2017/0151513 A1
(43) Pub. Date: Jun. 1, 2017

(54) BALLAST WATER TREATMENT DEVICE

(71) Applicant: MIURA CO., LTD., Matsuyama-shi (JP)

(72) Inventors: Tomoaki TANGE, Matsuyama-shi (JP); Yoshinobu HIRAKI, Matsuyama-shi (JP)

(73) Assignee: MIURA CO., LTD., Matsuyama-shi (JP)

(21) Appl. No.: 15/352,283

(22) Filed: Nov. 15, 2016

(30) Foreign Application Priority Data
Dec. 1, 2015 (JP) 2015-234840
Oct. 25, 2016 (JP) 2016-208819

(51) Int. Cl. B01D 29/68; C02F 1/32

(52) U.S. Cl. CPC B01D 29/68; C02F 1/32; C02F 2103/008

(57) ABSTRACT

Provided is a ballast water treatment device with which filter clogging can be effectively eliminated by backwash using a simple configuration. The ballast water treatment device is provided with: a filter 52; an introduction line L1; a line L11through which the ballast water W2 filtered by the filter 52 flows; a flow rate adjustment unit (valve V12) for adjusting the flow rate of the ballast water W2 that flows through the line L11; and a flow rate control unit (control unit 9) for controlling the flow rate adjustment unit V12. The flow rate control unit 9, in a situation where the filtering capability of the filter 52 is decreased, controls the flow rate adjustment unit V12 so as to increase the pressure on a secondary side of the filter 52 by decreasing the flow rate of the ballast water W2, and the filter 52 is then subjected to backwash with the pressure on the secondary side of the filter 52 having been increased.

### BACKGROUND

1. Technical Field

The present invention relates to a ballast water treatment device provided with a filter for filtering ballast water.

2. Related Art

A vessel such as a tanker usually stores water called ballast water in a ballast tank disposed on the vessel in order to balance the vessel under way while traveling toward another destination after unloading freight such as crude petroleum. Ballast water is normally charged at an unloading port and discharged at a loading port. Therefore, if these ports are located at different places, microorganisms such as plankton and bacteria in the ballast water comes to travel all over the world. Thus, ballast water is discharged at a loading port in a sea area different from that of an unloading port, and microorganisms in another sea area are released at the loading port and may destroy the ecosystem in the sea area.

In order to decrease the amount of microorganisms contained in the ballast water, a ballast water treatment device equipped with a filter for filtering ballast water may be used. The filter of the ballast water treatment device is required to provide high levels of microorganisms removal performance, and therefore requires a filtering body of, e.g., wire netting with an extremely small mesh opening. Accordingly, the filter easily becomes clogged, and regular filter rinsing (backwash) is important.

WO 2015/068245 A and JP-A-2014-227063 describe ballast water treatment devices which perform regular filter rinsing (backwash) to prevent clogging. Specifically, a filtering process of filtering the ballast water that has entered the filter and draining the ballast water to the outside is performed simultaneously with a backwash process of spraying backwash water onto the outer peripheral surface of the filter to thereby peel off attached matter on the filter while suctioning the peeled attached matter together with the backwash water (simultaneous filtering and backwash process; which may also be referred to as “filtering/backwash process”).

JP-T-2014-534060 describes a ballast water treatment device including a plurality of filters, in which a backwash process is performed on the filters of which a differential pressure between internal pressure and external pressure has become equal to or greater than a predetermined value, so as to control the backwash to be performed smoothly.

However, if the above-described filtering/backwash process is continued, filamentous living organisms or substance may become entangled with the filter, viscous substance may become attached, or substance may enter portions that are hard to peel by normal suctioning. In such cases, it is necessary to stop the filtering/backwash process and perform stronger backwash. For example, backwash (spatial rinsing) is performed with substantially no presence of ballast water in the filter. After the substance attached to the filter is removed by the strong backwash, the filtering/backwash process is resumed.

### SUMMARY

However, when a backwash is performed without the presence of ballast water in the filter, the filtering/backwash process is once stopped, so that it takes time to start up the device upon resumption.

Accordingly, a need exists for a ballast water treatment device which is capable of effectively eliminating filter clogging by continuously performing the simultaneous filtering and backwash process in a simple configuration, and which has high operating efficiency.

An object of the present invention is to provide a ballast water treatment device which is capable of effectively eliminating filter clogging by continuously performing the simultaneous filtering and backwash process in a simple configuration, and which therefore has high operating efficiency.

The present invention relates to a ballast water treatment device including a filter for filtering ballast water; an introduction line for introducing the ballast water to a primary side of the filter; a line through which the ballast water filtered by the filter flows toward a ballast tank; a flow rate adjustment unit for adjusting a flow rate of the line through which the ballast water flows; and a flow rate control unit for controlling the flow rate adjustment unit. The flow rate control unit, in a situation where a filtering capability of the filter is decreased due to attachment of foreign matter on the filter, controls the flow rate adjustment unit so as to increase the pressure on a secondary side of the filter by decreasing the flow rate of the ballast water that has been filtered by the filter. The filter is then subjected to backwash with the pressure on the secondary side of the filter having been increased.

Preferably, the ballast water treatment device may further include a backwash water spray nozzle configured to spray backwash water toward a surface on the secondary side of the filter. The flow rate control unit may perform the spraying of the backwash water using the backwash water spray nozzle, with the pressure on the secondary side of the filter having been increased.

Preferably, the situation where the filtering capability of the filter is decreased may be a situation where a differential pressure between the primary side and the secondary side of the filter is equal to or greater than a reference differential pressure. The ballast water treatment device may further include a differential pressure detection unit for detecting the differential pressure between the primary side and the secondary side of the filter. The flow rate control unit, when the differential pressure detected by the differential pressure detection unit has become equal to or greater than the reference differential pressure, may control the flow rate adjustment unit so as to increase the pressure on the secondary side of the filter by decreasing the flow rate of the ballast water that has been filtered by the filter.

Preferably, the situation where the filtering capability of the filter is decreased may be a situation where a filtering time of the filter has become equal to or greater than a reference time. The ballast water treatment device may further include a filtering time measurement unit for measuring the filtering time of the filter. The flow rate control unit, when the filtering time measured by the filtering time measurement unit has become equal to or greater than the reference time, may control the flow rate adjustment unit so as to increase the pressure on the secondary side of the filter by decreasing the flow rate of the ballast water that has been filtered by the filter.

Preferably, the ballast water treatment device may further include a secondary-side pressure sensor that detects the pressure on the secondary side of the filter. The flow rate control unit, when the pressure on the secondary side of the filter detected by the secondary-side pressure sensor is equal to or greater than a set upper-limit pressure value, may control the flow rate adjustment unit so as to decrease the ballast water introduced from the introduction line to the primary side of the filter.

Preferably, the flow rate control unit, when the flow rate adjustment unit is controlled so as to decrease the ballast water introduced from the introduction line to the primary side of the filter, may control the flow rate adjustment unit so as to maintain the flow rate of the ballast water that has been filtered by the filter.

According to the present invention, filter clogging can be effectively eliminated by continuously performing a simultaneous filtering and backwash process in a simple configuration. Accordingly, a ballast water treatment device having high operating efficiency can be provided.

### BRIEF DESCRIPTION OF DRAWINGS

FIG. 1 is a flow diagram of a first embodiment of a ballast water treatment device according to the present invention;

FIG. 2 is a flowchart of filter rinsing control in the first embodiment of the present invention;

FIG. 3 is a flowchart of filter rinsing control in the second embodiment of the present invention; and

FIG. 4 is a flowchart of filter rinsing control in the third embodiment of the present invention.

### DETAILED DESCRIPTION

### First Embodiment

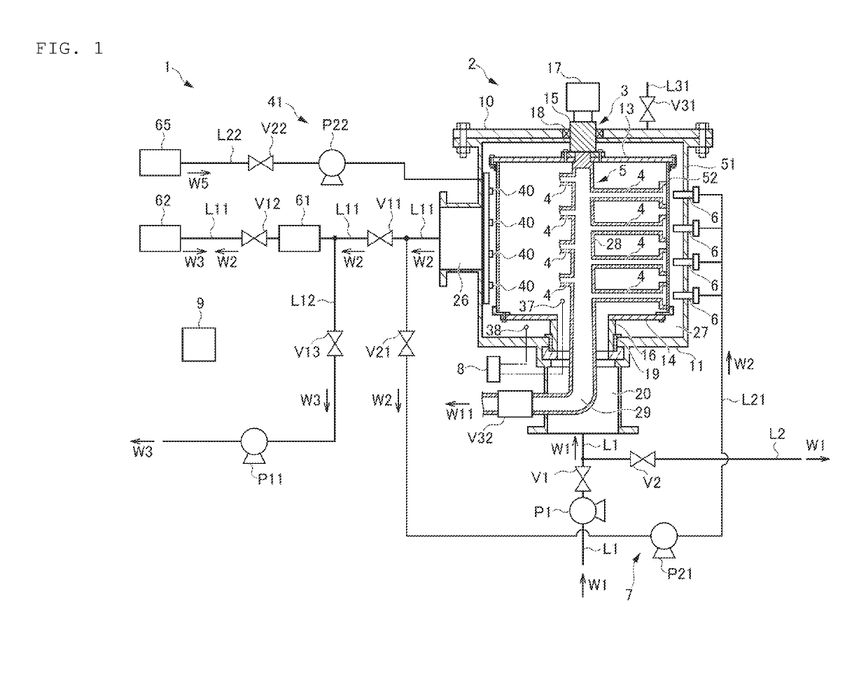

The ballast water treatment device according to a first embodiment of the present invention will be described with reference to the drawings. FIG. 1 is a flow diagram of the ballast water treatment device according to the first embodiment of the present invention.

As illustrated in FIG. 1, the ballast water treatment device 1 according to the first embodiment is provided with a ballast water filtering device 2, an ultraviolet reactor 61, a first backwash water supply unit 7, a second backwash water supply unit 41, and a control unit 9. The control unit 9 is connected, via signal lines (not illustrated), to various units to be controlled so as to be able to control the units. The ballast water treatment device 1 has a ballast tank 62 and a clean water tank 65 connected thereto as external configurations.

The ballast water treatment device 1 according to the first embodiment is provided with lines including a line L1 as an introduction line; a line L2; a line L11; a line L12; a line L21; a line L22; and a line L31. The “line” is a general term for lines through which fluid can flow, such as flow passageways, routes, and pipe conduits.

The ballast water filtering device 2 is provided with a casing 51; a filter 52; a filter rotation unit 3; suction nozzles 4; first backwash water spray nozzles 6 as backwash water spray nozzles; second backwash water spray nozzles 40; a drainage water discharge unit 5; and a differential pressure detection unit 8.

The casing 51 is cylindrical and has the filter 52 housed therein. The filter 52 is cylindrical as viewed as a whole, and configured to filter the ballast water (water to be treated) W1 (which is mainly sea water) that has entered therein to obtain ballast water (filtering-processed water) W2, which is drained to the outside. The filter rotation unit 3 rotates the filter 52 about a shaft center thereof. The suction nozzles 4 are disposed on a primary side of the filter 52 and opened toward an inner peripheral surface of the filter 52.

The first backwash water spray nozzles 6 are disposed on a secondary side of the filter 52 to spray backwash water (first backwash water) toward an outer peripheral surface of the filter 52 during a ballast water treatment operation. The spraying of the first backwash water from the first backwash water spray nozzles 6 is performed with the casing 51 and the filter 52 having (filled with) the ballast water (W2, W1).

The second backwash water spray nozzles 40 are disposed on the secondary side of the filter 52 separately from the first backwash water spray nozzles 6, and configured to spray backwash water (second backwash water W5) toward the outer peripheral surface of the filter 52. The spraying of the second backwash water W5 from the second backwash water spray nozzles 40 is performed with the casing 51 and filter 52 having substantially no ballast water (W2, W1) therein (i.e., with the second backwash water W5 from the second backwash water spray nozzles 40 directly (instead of underwater) hitting the filter 52) (spatial rinsing).

The drainage water discharge unit 5 discharges the ballast water suctioned by the suction nozzles 4 (the ballast water may be referred to as “drainage water W11”) from the inside of the casing 51 to the outside. The differential pressure detection unit 8 detects a differential pressure between the primary side and the secondary side of the filter 52.

The control unit 9, based on the differential pressure and the like detected by the differential pressure detection unit 8, controls the presence or absence of backwash water spray; switching between the first backwash water spray nozzles 6 and the second backwash water spray nozzles 40; and the spray pressure at the time of backwash water spray, for example.

The details of the ballast water filtering device 2 will be described later.

The ultraviolet reactor 61 performs ultraviolet ray irradiation on the ballast water (filtering-processed water) W2 filtered by the filter 52 of the ballast water filtering device 2.

The ballast tank 62 stores the ballast water (filtering-processed water) W2 that has been subjected to ultraviolet ray irradiation by the ultraviolet reactor 61 as stored treated water W3.

In addition, the ultraviolet reactor 61, when the ballast water stored in the ballast tank 62 (stored treated water) W3 is discharged overboard, performs ultraviolet ray irradiation on the stored treated water W3.

The clean water tank 65 stores clean water W5 prepared separately from the ballast water.

The term “ballast water” may be used regardless of whether before being introduced (entered) into the ballast tank 62 or after being discharged (drained) from the ballast tank 62; whether before being introduced (entered) into the filter 52 or after being discharged (drained) from the filter 52; or whether before being introduced (entered) into the ultraviolet reactor 61 or after being discharged (drained) from the ultraviolet reactor 61. Depending on the situation, the “ballast water” may be appropriately referred to as “water to be treated”, “filtering-processed water”, “stored treated water”, “drainage water” or the like. The ballast water may include sea water, fresh water, and brackish water.

The respective lines will be described. The line L1 has the ballast water W1 (mainly sea water) introduced thereto via one end thereof, the other end being connected to an introduction opening 20 of the ballast water filtering device 2. The line L1 is a line through which the ballast water W1 flows toward the introduction opening 20 of the ballast water filtering device 2. The line L1 has a pump P1 and a valve V1 disposed therein in that order. The pump P1 pumps up the ballast water W1 from one end of the line L1.

The line L2 has one end connected between the pump P1 in the line L1 and the introduction opening 20, the other end being opened to the outside. The line L2 has a valve

V2 disposed therein. The line L2 is used when discharging the water (ballast water W1, second backwash water W5) in the filter 52.

The line L11 has one end connected to an outflow opening 26 of the ballast water filtering device 2, the other end being connected to the ballast tank 62. The line L11 is a line through which the ballast water W2 filtering-treated by the ballast water filtering device 2 flows toward the ballast tank 62. The line L11 has a valve V11, the ultraviolet reactor 61, and a valve V12 disposed therein in that order.

The valve V12 functions as a flow rate adjustment unit for adjusting the flow rate of the ballast water W2 flowing through the line L11, and may be hereafter referred to as “flow rate adjustment valve V12” as appropriate. The flow rate adjustment valve V12 is a proportional control valve of which the opening degree is adjusted responsive to a control signal from the control unit 9. During the filtering process for the ballast water W1, the flow rate adjustment valve V12 is adjusted to a predetermined normal opening degree (for example, approximately full-open).

The line L12 has one end connected between the valve V11 of the line L11 and the ultraviolet reactor 61, with the other end being opened to the outside. The line L12 is a line for discharging the ballast water W3 to the outside. The line L12 has a valve V13 and a pump P11 disposed in that order.

The line L21 has one end connected between the outflow opening 26 of the ballast water filtering device 2 and the valve V11 of the line L11, the other end being connected to the first backwash water spray nozzles 6. The line L21 has a valve V21 and a pump P21 disposed in that order. More specifically, the other end of the line L21 is diverted into a plurality of branches which are respectively connected to the first backwash water spray nozzles 6. In the present embodiment, the line L21 has the ballast water (first backwash water) W2 flowing therethrough toward the first spray nozzles 6. The pump P21 pressurizes the water flowing through the line L21. Accordingly, the first backwash water W2 is sprayed at high pressure into the casing 51 and the filter 52.

The line L22 has one end connected to the clean water tank 65, the other end being connected to the second backwash water spray nozzles 40. The line L22 has the clean water W5 stored in the clean water tank 65 flowing therethrough toward the second backwash water spray nozzles 40 as the second backwash water. The line L22 has a valve V22 and a pump P22 disposed in that order.

The line L31 has one end connected to the top of the ballast water filtering device 2, the other end being opened to the outside. The line L31 has a valve V31 disposed therein. The line L31 is used to discharge the air in the ballast water filtering device 2 to the outside.

The details of the ballast water filtering device 2 will be described. As described above, the ballast water filtering device 2 is provided with the casing 51, the filter 52, the filter rotation unit 3, the suction nozzles 4, the first spray nozzles 6, the second backwash water spray nozzles 40, the drainage water discharge unit 5, and the differential pressure detection unit 8.

The casing 51 is formed in a cylindrical shape including an upper opening portion and a lower opening portion. The upper opening portion is sealed with a lid portion 10, and the lower opening portion is sealed with a bottom portion 11. The lid portion 10 has the line L31 connected thereto.

The filter 52 includes an upper opening portion and a lower opening portion, and is formed in a cylindrical shape as viewed as a whole. Between the casing 51 and the filter 52, a treatment water outflow space 27 is formed. The upper opening portion is sealed with an upper closure portion 13. The lower opening portion is sealed with a lower closure portion 14 and a lower rotating shaft member 16, which will be described below.

The filter rotation unit 3 is configured of the upper rotating shaft member 15, the lower rotating shaft member 16, and a motor 17 for rotating the upper rotating shaft member 15. The upper rotating shaft member 15 is disposed at a shaft center position of the filter 52 on the upper closure portion 13 of the filter 52, so as to protrude upward in a shaft center direction. The lower rotating shaft member 16 is disposed at the shaft center position of the filter 52 on the lower closure portion 14 of the filter 52, so as to protrude downward in the shaft center direction.

The upper rotating shaft member 15 is supported, via a bearing member 18 which penetrates through the lid portion 10 of the casing 51 and is sealed, in the lid portion 10 in a freely rotatable and liquid-tight manner. The lower rotating shaft member 16 is supported, via a bearing member 19 which penetrates through the bottom portion 11 of the casing 51 and is sealed, in the bottom portion 11 in a freely rotatable and liquid-tight manner. The lower rotating shaft member 16 is a tubular member communicating with the inside of the filter 52, and protrudes from the bottom portion 11 of the casing 51 to the outside of the casing 51. The lower rotating shaft member 16 has the introduction opening 20 to the casing 51 connected thereto.

The introduction opening 20 has the line L1 connected thereto. In the side of the casing 51, the outflow opening 26 is provided. The outflow opening 26 has the line L11 connected thereto.

The ballast water W1 that has been flowed through the introduction line L1 and introduced via the introduction opening 20 passes through the lower rotating shaft member 16 and enters the inside of the filter 52. The ballast water W1 is filtered as it passes through the filter 52, enters the treatment water outflow space 27 formed between the casing 51 and the filter 52, and flows out via the outflow opening 26.

The drainage water discharge unit 5 is provided with a collecting pipe 28, a discharge pipe 29, and a valve V32. The collecting pipe 28 is connected to the suction nozzles 4. The collecting pipe 28 collects the drainage water W11 suctioned by the suction nozzles 4. The discharge pipe 29 is connected to the lower end of the collecting pipe 28 to discharge the drainage water W11 to the outside. The valve V32 is disposed at the downstream-side end of the discharge pipe 29.

The collecting pipe 28 has the upper end thereof closed, with the lower end being open. The collecting pipe 28 is disposed at a position aligned with the shaft center of the filter 52. The upper end of the collecting pipe 28 is supported by being fitted in a hole provided at the center of the upper closure portion 13 of the filter 52. The lower end of the collecting pipe 28 is connected to the upper end (one end) of the discharge pipe 29.

The discharge pipe 29 is disposed in the lower rotating shaft member 16 of the lower closure portion 14 of the filter 52 so as not to interfere with the rotation of the filter 52, and is supported by being secured in the introduction opening 20 of the casing 51.

The suction nozzles 4 are connected to the collecting pipe 28 and opened toward the inner peripheral surface of the filter 52. The suction nozzles 4 are preferably configured to be able to suction from the entire area in the axial direction of the filter 52. The configuration of the suction nozzles 4 is not particularly limited. For example, the suction nozzles 4 may be disposed side by side linearly along the axial direction of the filter 52, or may be disposed with varying angles in the circumferential direction. A plurality of suction nozzles 4 disposed with varying angles in the circumferential direction may be disposed at the same height, or may be disposed at varying heights.

In the present embodiment, the plurality of suction nozzles 4 are disposed side by side linearly in the axial direction of the filter 52 (vertical direction), and connected to the collecting pipe 28. The plurality of suction nozzles 4 are also disposed at predetermined intervals along the axial direction of the filter 52. The opening portions of the suction nozzles 4 opened toward the filter 52 at the position opposing the inner peripheral surface of the filter 52 are placed in close contact with the inner peripheral surface of the filter 52 slidably.

In order to eliminate non-suctioned portions between the plurality of suction nozzles 4 disposed in the vertical direction, as illustrated in FIG. 1, the plurality of suction nozzles 4 are disposed on the right and left sides of the collecting pipe 28 alternately in the height direction. This enables suctioning to be performed from the entire area of the inner peripheral surface of the filter 52 by a single rotation of the filter 52. As another example of disposing the plurality of suction nozzles 4 at varying heights along the axial direction of the filter 52, the plurality of suction nozzles 4 may be disposed spirally along the axial direction of the filter 52 at intervals such that no non-suctioned portion is present between the suction nozzles 4.

The first backwash water spray nozzles 6 are disposed on the side of the casing 51, and opened into the casing 51. The first backwash water spray nozzles 6 are preferably able to spray the first backwash water onto the entire area in the axial direction of the filter 52. The configuration of the first backwash water spray nozzles 6 is not particularly limited. For example, the first backwash water spray nozzles 6 may be disposed side by side linearly along the axial direction of the filter 52, or may be disposed with varying angles in the circumferential direction. A plurality of first backwash water spray nozzles 6 disposed with varying angles in the circumferential direction may be disposed at the same height, or may be disposed at varying heights.

The first backwash water supply unit 7 pressurizes and supplies the ballast water W2 filtering-treated by the filter 52 to the first backwash water spray nozzles 6 as the first backwash water W2. The first backwash water supply unit 7 is configured of the pump P21, the valve V21 and the like.

By means of the suction nozzles 4, drainage water discharge unit 5, first backwash water spray nozzles 6, and first backwash water supply unit 7, peeled foreign matter deposited on the primary side of the filter 52 is suctioned via the suction nozzles 4, and the suctioned foreign matter flows in the collecting pipe 28 and discharged to the outside via the discharge pipe 29.

The first backwash water spray nozzles 6 are also used to spray the first backwash water W2 supplied from the first backwash water supply unit 7 onto the outer peripheral surface of the filter 52 (secondary side), so as to strongly peel the foreign matter deposited on the primary side of the filter 52.

The suctioning of the foreign matter via the suction nozzles 4 occurs as the pressure inside the suction nozzles 4 becomes lower than the pressure outside the suction nozzles 4 (on the secondary side of the filter 52). That is, when the valve V32 of the drainage water discharge unit 5 is opened, the secondary side of the valve V32 is opened to the atmospheric pressure, whereby the pressure inside the collecting pipe 28 becomes lower than the pressure on the secondary side of the filter 52. Accordingly, some of the ballast water (filtering-processed water) W2 present on the secondary side of the filter 52 and the first backwash water W2 sprayed via the first backwash water spray nozzles 6 flow through the collecting pipe 28 and discharged via the discharge pipe 29 to the outside as the drainage water W11.

The differential pressure detection unit 8 detects the differential pressure between the primary side and the secondary side of the filter 52. The differential pressure detection unit 8 is provided with a primary-side pressure sensor 37 disposed in the filter 52, and a secondary-side pressure sensor 38 disposed in the treatment water outflow space 27. The differential pressure detection unit 8 detects the differential pressure between the primary side and the secondary side of the filter 52 by sensing the pressure on the primary side of the filter 52 using the primary-side pressure sensor 37, and the pressure on the secondary side of the filter 52 using the secondary-side pressure sensor 38. Based on the differential pressure between the primary side and the secondary side of the filter 52, the level of contamination of the filter 52 can be determined. A large differential pressure indicates that the filter 52 has a large amount of foreign matter deposited thereon; a small differential pressure indicates that the filter 52 is in a state close to its initial state (a state with a small amount of deposited foreign matter).

The second backwash water spray nozzles 40 are disposed on the side of the casing 51, and opened toward the inside of the casing 51. The second backwash water spray nozzles 40 are preferably configured to be able to spray the second backwash water onto the entire area in the axial direction of the filter 52. The configuration of the second backwash water spray nozzles 40 is not particularly limited. For example, the second backwash water spray nozzles 40 may be linearly disposed side by side along the axial direction of the filter 52, or may be disposed with varying angles in the circumferential direction. A plurality of second backwash water spray nozzles 40 disposed with varying angles in the circumferential direction may be disposed at the same height, or may be disposed at varying heights.

The second backwash water supply unit 41 pressurizes and supplies the clean water W5 stored in the clean water tank 65 to the second backwash water spray nozzles 40 as the second backwash water W5. The second backwash water supply unit 41 is configured of the valve V22, the pump P22 and the like.

As the first backwash water supplied to the first backwash water spray nozzles 6 in the present embodiment, the ballast water W2 filtering-treated by the filter 52 (filtering-processed water) is used. As the second backwash water supplied to the second backwash water spray nozzles 40 in the present embodiment, the clean water W5 stored in the clean water tank 65 is used. As the first backwash water to the filter 52, the clean water W5 stored in the clean water tank 65 may be used, for example.

The second backwash water spray nozzles 40, after the end of the ballast water treatment operation with the water in the casing 51 having been discharged (with substantially no ballast water W1 present in the filter 52), spray the second backwash water W5 onto the outer peripheral surface of the filter 52 (secondary side), so as to strongly peel off the foreign matter deposited on the inner peripheral surface of the filter 52 (primary side). That is, the second backwash water W5 is sprayed via the second backwash water spray nozzles 40 onto the outer peripheral surface of the filter 52 being rotated, with substantially no ballast water W1 present inside the filter 52.

The control unit 9 controls various units to be controlled. In particular, the control unit 9 also functions as a flow rate control unit for controlling the flow rate adjustment valve V12. Specifically, the control unit 9, in a situation where the filtering capability of the filter 52 is decreased due to the attachment of foreign matter on the filter 52, controls the flow rate adjustment valve V12 so as to increase the pressure on the secondary side of the filter 52 by decreasing the flow rate of the ballast water W2 filtered by the filter 52 (filtering-processed water).

In the first embodiment, the situation where the filtering capability of the filter 52 is decreased is the situation where the differential pressure between the primary side and the secondary side of the filter 52 is equal to or greater than a reference differential pressure. Accordingly, the control unit 9, when the differential pressure detected by the differential pressure detection unit 8 is equal to or greater than the reference differential pressure, controls the flow rate adjustment valve V12 so as to increase the pressure on the secondary side of the filter 52 by decreasing the flow rate of the ballast water W2 filtered by the filter 52 (filtering-processed water).

Then, the control unit 9, with the pressure on the secondary side of the filter 52 having been increased, controls various units, such as the first backwash water spray nozzles 6, so as to spray the backwash water W2 using the first backwash water spray nozzles 6.

Thus, in the first embodiment, based on the differential pressure detected by the differential pressure detection unit 8, the opening degree of the flow rate adjustment valve V12 disposed in the line L11 is decreased so as to increase the internal pressure of the casing 51 (specifically, the pressure on the secondary side of the filter 52), and then strong backwash, which is stronger than normal backwash, is performed.

Main operations of the ballast water treatment device 1 according to the present embodiment will be briefly described.

### (1) Filtering Process for Ballast Water (Water to be Treated) W1 by Ballast Water Filtering Device 2

When the filtering process for the ballast water W1 is performed, the control unit 9 opens the valve V1, valve V11, and valve V12, and closes the valve V2, valve V13, valve V21, valve V31, and valve V32. In this state, the pump P1 is driven. Accordingly, the ballast water W1 that has entered via the one end of the introduction line L1 flows through the introduction line L1. The ballast water W1 introduced via the introduction opening 20 is filtering-treated by the filter 52, and discharged as the ballast water (filtering-processed water) W2 via the outflow opening 26. The filtering-treated ballast water W2 flows through the line L11, ultraviolet-treated by the ultraviolet reactor 61, and stored in the ballast tank 62 as the stored treated water W3.

The flow rate adjustment valve V12, for the filtering process for the ballast water W1, is adjusted to a predetermined normal opening degree (for example, approximately full-open).

### (2) Backwash Process for Filter 52 by First Backwash Water Spray Nozzles 6 (Backwash During Ballast Water Treatment Operation)

When backwash process is performed during a ballast water treatment operation, the control unit 9 opens the valve V1, valve V11, valve V12, valve V21, and valve V32, and closes the other valves so as to obtain the state in which the ballast water (filtering-processed water) W2 flows toward the first backwash water spray nozzles 6. Then, with the ballast water (W2, W1) present in the casing 51 and the filter 52, the pump P21 is operated. By operating the pump P21, the first backwash water W2 from the first backwash water spray nozzles 6 is sprayed toward the filter 52; by opening the valve V32, the suctioning by the suction nozzles 4 is started and backwash is performed.

In the first embodiment, the backwash is a normal backwash performed when the differential pressure ΔP detected by the differential pressure detection unit 8 is less than a predetermined reference differential pressure Pth.

In addition, the backwash is a normal backwash performed when, in the second embodiment to be described below, a filtering time Tc of the filter 52 is less than a predetermined reference time Tm.

### (3) Backwash Process for Filter 52 by Second Backwash Water Spray Nozzles 40 (Spatial Rinsing)

When backwash is performed using the second backwash water spray nozzles 40, the control unit 9, after the end of the filtering process for the ballast water W1, opens the valve V2 in the line L2 and the valve V31 in the line L31, and closes the other valves, so as to discharge the water in the filter 52. Then, with substantially no ballast water (W2, W1) present in the casing 51 and the filter 52, the valve V32 disposed in the discharge pipe 29 and the valve V22 disposed in the line L22 are opened, and the pump P22 is operated. Accordingly, the clean water W5 stored in the clean water tank 65 flows through the line L22, pressurized by the pump P22, and sprayed via the second backwash water spray nozzles 40 toward the filter 52 as the second backwash water W5 , whereby backwash is performed.

### (4) Drainage Process for Ballast Water (Stored Treated Water) W3 from Ballast Tank 62 to the Outside

When the ballast water (stored treated water) W3 is drained, the control unit 9 opens the valve V12 and valve V13, and closes the other valves. In this state, the pump P11 disposed in the line L12 is operated. Accordingly, the ballast water W3 stored in the ballast tank 62 is ultraviolet-treated by the ultraviolet reactor 61, and then discharged to the outside via a part of the line L11 and the line L12.

While the main operations of the ballast water treatment device 1 according to the present embodiment have been described, the first embodiment is configured such that, when the differential pressure ΔP has become equal to or greater than the predetermined reference differential pressure Pth in the situation where the filtering capability of the filter is decreased, the strong backwash stronger than normal backwash is performed.

With reference to the drawings, the control in the case where the strong backwash is performed will be described.

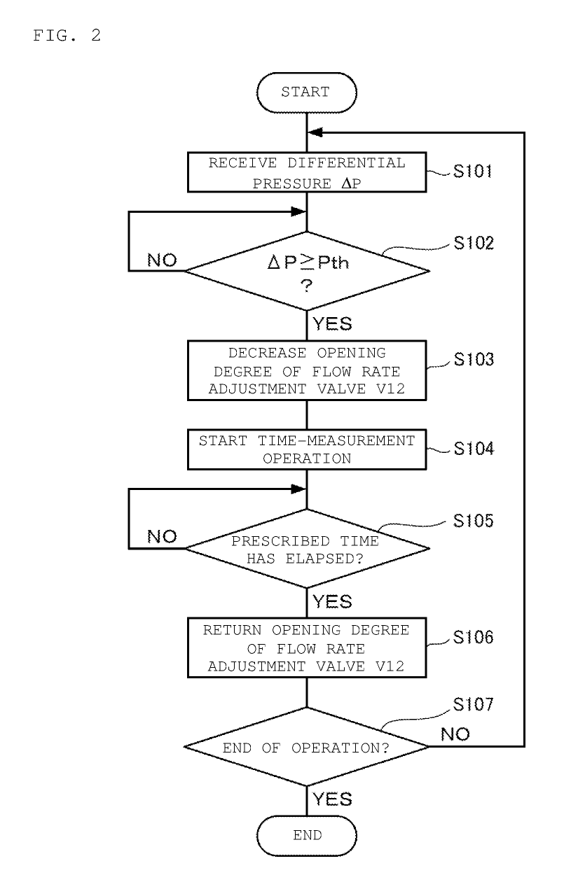

FIG. 2 is a flowchart of filter rinsing control in the first embodiment of the present invention, particularly the control in the control unit 9 when strong backwash is performed.

In the backwash process during a ballast water treatment operation, initially, the flow rate adjustment valve V12 is set to the above-described normal opening degree (for example, approximately full-open).

When the backwash process operation is started, in step S101, the control unit 9 receives the differential pressure ΔP between the primary side and the secondary side of the filter 52 detected by the differential pressure detection unit 8.

Then, in step S102, the control unit 9 determines whether the differential pressure ΔP received in step S101 is equal to or greater than the reference differential pressure Pth.

The control unit 9, if it is determined that the differential pressure ΔP is less than the reference differential pressure Pth (ΔP<Pth) (step S102: NO), controls the flow rate adjustment valve V12 so as to maintain the opening degree of the flow rate adjustment valve V12 at the normal opening degree (for example, approximately full-open).

On the other hand, if it is determined that the differential pressure ΔP is equal to or greater than the reference differential pressure Pth (ΔP≧Pth) (step S102: YES), the control unit 9 in step S103 relatively decreases the opening degree of the flow rate adjustment valve V12.

It should be noted, however, that while the opening degree of the flow rate adjustment valve V12 may be decreased, it is not fully closed. Instead, the opening degree is set to an opening degree such that a certain flow rate of the ballast water (water to be treated) W1 can be maintained. In this way, the filtering of the ballast water (water to be treated) W1 is continued at a relatively small flow rate without being interrupted.

As described above, the differential pressure ΔP is correlated with the level of contamination of the filter 52, i.e., the amount of deposited foreign matter on the filter 52. If the differential pressure ΔP is equal to or greater than the reference differential pressure Pth, the amount of deposited foreign matter on the filter 52 is large. This indicates a so-called stubbornly clogged state or a state close thereto, with the resultant situation where the filtering capability of the filter 52 is decreased.

When the opening degree of the flow rate adjustment valve V12 is made smaller than normal opening degree as described above, the flow rate of the ballast water flowing through the line L11 is decreased, whereby the pressure in the casing 51, i.e., the pressure on the secondary side of the filter 52, is relatively increased.

The inventors, through various experiments conducted, have confirmed the phenomenon that the higher the pressure in the casing 51 (which may be referred to as “can pressure”) of the filter 52, the stronger backwash effect can be obtained.

In the first embodiment, this phenomenon is positively utilized. That is, by decreasing the opening degree of the flow rate adjustment valve V12, a strong backwash effect is obtained with the pressure in the casing 51 (the pressure on the secondary side of the filter 52) increased, whereby the foreign matter strongly deposited on the filter 52 can be strongly peeled off.

In the first embodiment, the duration of the strong backwash is managed by a time-measurement operation. That is, in step S104, while the control to decrease the opening degree of the flow rate adjustment valve V12 is performed in step S103, the control unit 9 starts a time-measurement operation.

In step S105, the control unit 9 determines whether a prescribed time has elapsed. Until the prescribed time elapses from when the opening degree of the flow rate adjustment valve V12 was decreased (step S105: NO), the control unit 9 maintains the opening degree of the flow rate adjustment valve V12 to continue the strong backwash. When the prescribed time is reached (step S105: YES), in step S106, the control unit 9 returns the opening degree of the flow rate adjustment valve V12 back to normal opening degree.

The prescribed time may be set based on experimental data or operation results data and the like obtained during the operation of the ballast water treatment device.

The control unit 9, in step S107, after returning the opening degree of the flow rate adjustment valve V12 back to normal opening degree in step S106, determines whether an instruction for ending the operation of the ballast water treatment device 1 has been received. Until the control unit 9 recognizes in step S107 the reception of the instruction for ending the operation (step S107: NO), the process keeps returning to step S101. When the control unit 9 recognized in step S107 the reception of the instruction for ending the operation (step S107: YES), the process ends.

In the ballast water treatment device 1 according to the first embodiment as described above, with regard to the backwash of the filter 52, if the clogging of the filter 52 is relatively slight (the state where the amount of deposited foreign matter is relatively small) and the differential pressure ΔP between the primary side and the secondary side of the filter 52 is less than the reference differential pressure Pth (ΔP<Pth), backwash is performed as follows. That is, the opening degree of the flow rate adjustment valve V12 is maintained at the normal opening degree (for example, approximately full-open) so as to maintain a high filtering process efficiency without reducing the flow rate of the ballast water W1 that is filtering-treated (water to be treated).

On the other hand, if the clogging of the filter 52 is relatively severe (the state where the amount of deposited foreign matter is relatively large) and the differential pressure ΔP between the primary side and the secondary side of the filter 52 is equal to or greater than the reference differential pressure Pth (ΔP≧Pth), the opening degree of the flow rate adjustment valve V12 is decreased so as to increase the pressure in the casing 51 (the pressure on the secondary side of the filter 52) when the above-described strong backwash is performed. By continuing the strong backwash for a prescribed time, the foreign matter deposited on the filter 52 is strongly peeled off to recover filtering capability.

In this case, when the opening degree of the flow rate adjustment valve V12 is decreased, the flow rate of the ballast water (water to be treated) W1 that is filtering-treated is decreased. However, by purposefully decreasing, temporarily, the flow rate of the ballast water (water to be treated) W1 that is filtering-treated, the pressure in the casing 51 of the filter 52 (the can pressure, i.e., the pressure on the secondary side of the filter 52) is increased, whereby strong backwash can be performed during the prescribed time.

During the prescribed time, the flow rate of the ballast water (water to be treated) W1 is decreased. However, the filtering process for the ballast water (water to be treated) W1 is continued without interruption. Accordingly, the overall filtering process efficiency when the ballast water treatment device 1 is continuously operated can be maintained at high level.

The ballast water treatment device 1 according to the first embodiment provides the following effects, for example.

In the situation where the filtering capability of the filter 52 is decreased due to the attachment of foreign matter on the filter 52, or, specifically, when the differential pressure ΔP between the primary side and the secondary side of the filter 52 is equal to or greater than the reference differential pressure Pth, the control unit 9 controls the flow rate adjustment valve V12 so as to increase the pressure on the secondary side of the filter 52 by decreasing the flow rate of the ballast water W2 filtered by the filter 52 (filtering-processed water). The control unit 9, with the pressure on the secondary side of the filter 52 having been increased, controls various units so as to perform spraying of the backwash water W2 using the first backwash water spray nozzles 6.

Thus, by the extremely simple configuration in which the opening degree of the flow rate adjustment valve V12 is made smaller than normal opening degree, the pressure on the secondary side of the filter 52 (which may be referred to as can pressure) is increased by decreasing the flow rate of the ballast water W2 filtered by the filter 52 (filtering-processed water), whereby the clogging of the filter 52 can be effectively eliminated by backwash. That is, the clogging of the filter 52 can be effectively eliminated by continuously performing the simultaneous filtering and backwash process. Accordingly, high operating efficiency can be obtained.

By employing normal backwash and strong backwash in combination, even if the so-called stubbornly clogged state is encountered, the backwash can be continuously performed effectively without stopping the filtering process.

### Second Embodiment

The ballast water treatment device according to a second embodiment of the present invention will be described with reference to the drawings. The second embodiment will be described focusing on differences from the first embodiment. Therefore, detailed description of configurations that are identical (or equivalent) to those of the first embodiment is omitted. In addition, with regard to the points of the second embodiment that are not specifically described, descriptions for the first embodiment may apply or be used as appropriate.

In the first embodiment, the switching from normal backwash to strong backwash is performed based on the differential pressure ΔP between the primary side and the secondary side of the filter 52. The second embodiment differs in that the switching from normal backwash to strong backwash is performed based on the filtering time of the filter 52.

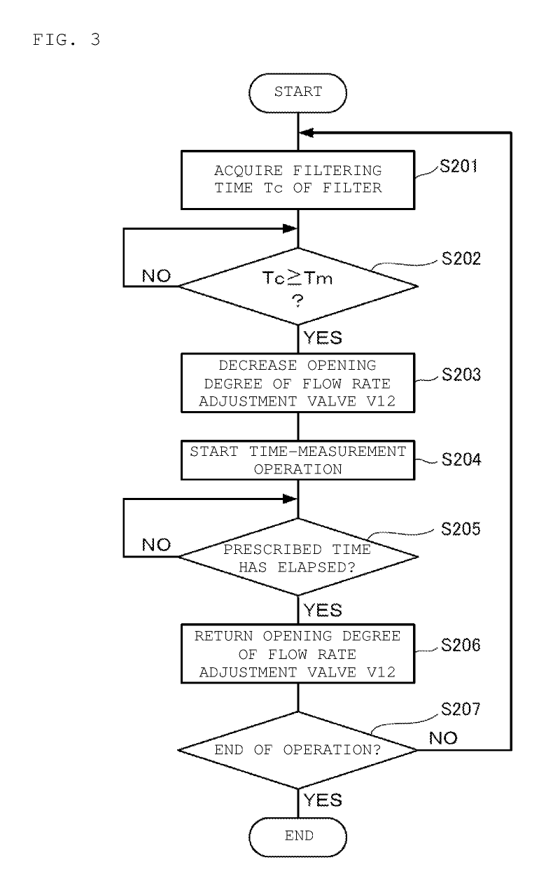

FIG. 3 is a flow diagram of the ballast water treatment device according to the second embodiment of the present invention.

In the second embodiment, the situation where the filtering capability of the filter 52 is decreased corresponds to a situation where the filtering time of the filter 52 has become equal to or greater than a reference time. The control unit 9 also functions as a filtering time measurement unit for measuring the filtering time Tc of the filter 52. Accordingly, in the second embodiment, the control unit 9, when the filtering time Tc measured by the control unit 9 serving as the filtering time measurement unit has become equal to or greater than a reference time Tm, controls the flow rate adjustment valve V12 so as to increase the pressure on the secondary side of the filter 52 by decreasing the flow rate of the ballast water W2 filtered by the filter 52 (filtering-processed water).

In the backwash process during a ballast water treatment operation, initially, the flow rate adjustment valve V12 is set to the above-described normal opening degree (for example, approximately full-open).

When the backwash process operation is started, in step S201, the control unit 9 serving as the filtering time measurement unit acquires the filtering time Tc.

In step S202, the control unit 9 determined whether the filtering time Tc acquired in step S201 is equal to or greater than the predetermined reference time Tm.

The control unit 9, if it is determined that the filtering time Tc is less than the reference time Tm (Tc<Tm) (step S202: NO), controls the flow rate adjustment valve V12 so as to maintain the opening degree of the flow rate adjustment valve V12 at the normal opening degree (for example, approximately full-open).

On the other hand, the control unit 9, if it is determined that the filtering time Tc is equal to or greater than the reference time Tm (Tc≧Tm) (step S202: YES), controls the flow rate adjustment valve V12 in step S203 so as to make the opening degree of the flow rate adjustment valve V12, which is an adjustment valve, relatively small.

As in the control according to the first embodiment, while the opening degree of the flow rate adjustment valve V12 may be decreased, it is not fully closed. Instead, the opening degree is set to an opening degree such that a certain flow rate of the ballast water (water to be treated) W1 that is filtered can be maintained. In this way, the filtering of the ballast water (water to be treated) W1 is continued at a relatively small flow rate without being interrupted.

The reference time Tm is set, based on experimental data or operation results data and the like obtained during the operation of the ballast water treatment device, to a filtering time assuming that the amount of deposited foreign matter on the filter 52 is large, and the so-called stubbornly clogged state or a state close thereto is present, with the resultant situation where the filtering capability of the filter 52 is decreased.

In the second embodiment too, as in the first embodiment, the duration of the strong backwash is managed based on a time-measurement operation. That is, in step S204, the control to decrease the opening degree of the flow rate adjustment valve V12 is performed in step S203 while the control unit 9 starts a time-measurement operation.

In step S205, the control unit 9 determines whether a prescribed time has elapsed. Until the prescribed time is elapses from when the opening degree of the flow rate adjustment valve V12 was decreased (step S205: NO), the control unit 9 causes strong backwash to continue while maintaining the opening degree of the flow rate adjustment valve V12. On the other hand, when the prescribed time is reached (step S205: YES), in step S206, the control unit 9 returns the opening degree of the flow rate adjustment valve V12 back to normal opening degree (step S206).

The prescribed time may be set based on experimental data or operation results data and the like obtained during the operation of the ballast water treatment device, as in the first embodiment.

In step S207, the control unit 9, after returning the opening degree of the flow rate adjustment valve V12 back to normal opening degree in step S206, determines whether an instruction for ending the operation of the ballast water treatment device 1 has been received. Until the control unit 9 recognizes the reception of the instruction for ending the operation in step S207 (step S207: NO), the process keeps returning to step S201. When the control unit 9 has recognized the reception of the instruction for ending the operation in step S207 (step S207: YES), the process ends.

In the ballast water treatment device 1 according to the second embodiment as described above, with regard to backwash, when the filtering time Tc of the filter 52 is less than the reference time Tm (Tc<Tm) and the clogging of the filter 52 is relatively slight (the state where the amount of deposited foreign matter is relatively small), backwash is performed as follows. That is, the opening degree of the flow rate adjustment valve V12 is maintained at the normal opening degree (for example, approximately full-open), whereby a high filtering process efficiency is maintained without reducing the flow rate of the ballast water that is filtered (water to be treated) W1.

On the other hand, when the filtering time Tc of the filter 52 has become equal to or greater than the reference time Tm (Tc≧Tm), the probability is high that the clogging of the filter 52 is relatively severe (the state where the amount of deposited foreign matter is relatively large), and that the filtering capability of the filter 52 is decreased. In this case, the opening degree of the flow rate adjustment valve V12 is decreased so as to perform strong backwash by increasing the pressure in the casing 51 (the pressure on the secondary side of the filter 52). By continuing the strong backwash for a prescribed time, the foreign matter deposited on the filter 52 is strongly peeled off.

The ballast water treatment device according to the second embodiment provides the following effects, for example.

The control unit 9, when the filtering time Tc measured by the control unit 9 serving as the filtering time measurement unit has become equal to or greater than a reference time Tm, controls the flow rate adjustment valve V12 so as to increase the pressure on the secondary side of the filter 52 by decreasing the flow rate of the ballast water W2 filtered by the filter 52 (filtering-processed water).

Thus, according to the second embodiment, if it is estimated, based on the filtering time of the filter 52, that the filtering capability of the filter 52 is decreased due to the attachment of foreign matter on the filter 52, the pressure on the secondary side of the filter 52 (which may be referred to as can pressure) is increased by decreasing the flow rate of the ballast water W2 filtered by the filter 52 (filtering-processed water), using the extremely simple configuration in which the opening degree of the flow rate adjustment valve V12 is made smaller than normal opening degree. In this way, filter clogging can be effectively eliminated by backwash.

### Third Embodiment

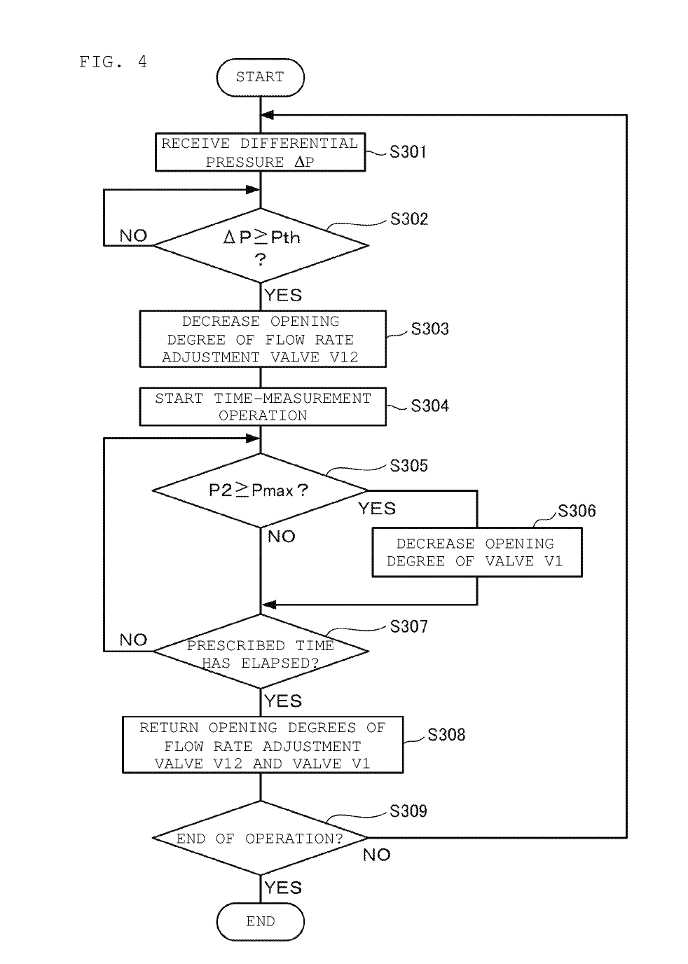

The ballast water treatment device according to a third embodiment of the present invention will be described with reference to FIG. 4. The ballast water treatment device according to the third embodiment differs from the first embodiment and the second embodiment in the method of adjusting the flow rate by the flow rate adjustment unit. That is, in the third embodiment, the control unit 9, while the control to increase the pressure on the secondary side of the filter 52 is being performed, if the pressure on the secondary side of the filter 52 (P2) has become equal to or greater than a preset upper-limit pressure value (Pmax), decreases the flow rate of the ballast water introduced from the introduction line L1 so as to suppress an excessive increase in the pressure of the filter 52. The upper-limit pressure value Pmax is set, for example, to a pressure value that would not put too much load on the filter 52.

FIG. 4 is a flowchart of filter rinsing control in the third embodiment of the present invention. In the backwash process during a ballast water treatment operation, initially, the flow rate adjustment valve V12 is set to a normal opening degree (for example, 35%).

When the backwash process operation is started, in step S301, the control unit 9 receives the differential pressure ΔP between the primary side and the secondary side of the filter 52 detected by the differential pressure detection unit 8.

Then, in step S302, the control unit 9 determines whether the differential pressure ΔP received in step S301 is equal to or greater than the reference differential pressure Pth.

The control unit 9, if it is determined that the differential pressure ΔP is less than the reference differential pressure Pth (ΔP<Pth) (step S302: NO), controls the flow rate adjustment valve V12 so as to maintain the opening degree of the flow rate adjustment valve V12 to the normal opening degree (for example, 35%).

On the other hand, the control unit 9, if it is determined that the differential pressure ΔP is equal to or greater than the reference differential pressure Pth (ΔP≧Pth) (step S302: YES), makes the opening degree of the flow rate adjustment valve V12 relatively small in step S303.

It should be noted, however, that while the opening degree of the flow rate adjustment valve V12 may be decreased, it is not fully closed. Instead, the opening degree is set to an opening degree such that a certain flow rate of the ballast water (water to be treated) W1 can be maintained (for example, opening degree 20%). In this way, the filtering of the ballast water (water to be treated) W1 is continued at a relatively small flow rate without being interrupted.

Then, in step S304, a control is performed to decrease the opening degree in step S303 of the flow rate adjustment valve V12, while the control unit 9 starts a time-measurement operation.

In step S305, the control unit 9 determines whether the pressure P2 on the secondary side of the filter 52 sensed by the pressure sensor 38 has become equal to or greater than the upper-limit pressure value Pmax.

The control unit 9, if it is determined that the pressure P2 on the secondary side is equal to or greater than the upper-limit pressure value Pmax (P2≧Pmax) (step S305: YES), decreases the opening degree of the valve V1 in step S306 (for example, an opening degree of 25%). At the same time, the control unit 9 increases the opening degree of the flow rate adjustment valve V12 to a predetermined opening degree (for example, an opening degree of 25%). In this way, the amount of the ballast water introduced into the ballast water filtering device 2 from the introduction line L1 is decreased. As a result, the pressure P2 on the secondary side is decreased, whereby an excessive increase of the pressure P2 on the secondary side can be suppressed. In addition, a decrease in the flow rate of the ballast water flowing through the line L11 due to a decrease in the flow rate of the ballast water introduced from the introduction line L1 can be supplemented by increasing the opening degree of the flow rate adjustment valve V12. Accordingly, the pressure P2 on the secondary side can be decreased without a further decrease in the flow rate of the ballast water filtered by the filter 52 (the flow rate of the ballast water flowing through the line L11).

In step S306, the control unit 9 may only decrease the opening degree of the valve V1 without modifying the opening degree of the flow rate adjustment valve V12. In addition, when the flow rate adjustment valve V12 is increased to the predetermined opening degree, the opening degree may be an opening degree smaller than the normal opening degree.

The control unit 9, if it is determined that the pressure P2 on the secondary side is less than the upper-limit pressure value Pmax (P2<Pmax) (step S302: NO), causes the process to proceed to step S307.

In step S307, the control unit 9 determines whether a prescribed time has elapsed. Until the prescribed time elapses from when the opening degree of the flow rate adjustment valve V12 was decreased (step S307: NO), the control unit 9 keeps the strong backwash to continue by maintaining the opening degree of the flow rate adjustment valve V12. When the prescribed time is reached (step S307: YES), the control unit 9 in step S308 returns the opening degree of the flow rate adjustment valve V12 and the opening degree of the valve V11 back to their normal opening degrees.

The above-described prescribed time may be set based on experimental data or operation results data and the like obtained during the operation of the ballast water treatment device.

In step S309, the control unit 9, after returning the opening degree of the flow rate adjustment valve V12 and the opening degree of the valve V1 to their normal opening degrees in step S308, determines whether an instruction for ending the operation of the ballast water treatment device 1 has been received. Until the control unit 9 recognizes the reception of the instruction for ending the operation in step S309 (step S309: NO), the process keeps returning to step S301. When the control unit 9 has recognized the reception of the instruction for ending the operation in step S309 (step S309: YES), the process ends.

The ballast water treatment device according to the third embodiment provides the following effects, as well as the effects similar to those of the first embodiment.

The control unit 9, while the control to increase the pressure on the secondary side of the filter 52 is being performed, if the pressure on the secondary side of the filter 52 (P2) has become equal to or greater than the preset upper-limit pressure value (Pmax), decreases the opening degree of the valve V1 so as to decrease the flow rate of the ballast water introduced from the introduction line L1. In this way, the amount of the ballast water introduced into the ballast water filtering device 2 from the introduction line L1 is decreased. As a result, the pressure P2 on the secondary side of the filter 52 is decreased, whereby an excessive increase of the pressure P2 on the secondary side can be suppressed. This makes it possible to prevent the filter 52 from experiencing an undesirable event due to an excessive increase of the pressure P2 on the secondary side. In addition, a decrease in the seal life in the ballast water filtering device 2, or the development of pressure oscillation in the ballast water filtering device 2 can be suppressed. Depending on the specification of the pump P1, when the opening degree of the flow rate adjustment valve V12 is decreased, the pressure on the secondary side of the filter 52 may be greatly increased. However, according to the present control, an excessive increase in the pressure on the secondary side of the filter 52 can be preferably prevented.

The control unit 9, when decreasing the opening degree of the valve V1 so as to decrease the flow rate of the ballast water introduced from the introduction line L1, increases the opening degree of the flow rate adjustment valve V12 to a predetermined opening degree. In this way, a decrease in the flow rate of the ballast water flowing through the line L11 due to a decrease in the flow rate of the ballast water introduced from the introduction line L1 can be supplemented by increasing the opening degree of the flow rate adjustment valve V12. Accordingly, the pressure P2 on the secondary side can be decreased without a further decrease in the flow rate of the ballast water filtered by the filter 52 (the flow rate of the ballast water flowing through the line L11).

While the present invention has been described with reference to preferred embodiments, the present invention is not limited to the foregoing embodiments and may be implemented in various modes.

For example, in the foregoing embodiments, when there is a severe decrease in the filtering capability of the filter 52 due to the attachment of foreign matter on the filter 52, the opening degree of the flow rate adjustment valve V12 is decreased so as to purposefully increase the pressure in the casing 51 of the filter 52 (the pressure on the secondary side of the filter 52), and then strong backwash is performed. However, this is not a limitation. When the filtering capability of the filter 52 is decreased even slightly, the opening degree of the flow rate adjustment valve V12 may be decreased immediately and strong backwash may be performed.

The flow rate adjustment unit for increasing the pressure on the secondary side of the filter by decreasing the flow rate of the ballast water that has been filtered by the filter is not limited to the flow rate adjustment valve V12.

In the foregoing embodiments, the duration of the strong backwash is managed based on a time-measurement operation. Instead, the duration may be managed based on the differential pressure ΔP between the primary side and the secondary side of the filter 52. That is, when the differential pressure ΔP is decreased to a fixed value indicating a recovery of the filter function of the filter 52, the opening degree of the flow rate adjustment valve V12 may be returned to the normal opening degree so as to recover the flow rate of the ballast water (water to be treated) W1 that is filtered, and then the strong backwash may be completed.

In the third embodiment, the control to suppress an excessive increase in the pressure of the filter 52 by decreasing the flow rate of the ballast water introduced from the introduction line L1 is applied to the control based on the differential pressure ΔP between the primary side and the secondary side of the filter 52 as described in the first embodiment. However, this is not a limitation. The control to suppress an excessive increase in the pressure of the filter 52 by decreasing the flow rate of the ballast water introduced from the introduction line L1 may be applied to the control based on the filtering time of the filter 52 as described in the second embodiment.

What is claimed is:

1. A ballast water treatment device comprising:
a filter for filtering ballast water;
an introduction line for introducing the ballast water to a primary side of the filter;
a line through which the ballast water filtered by the filter flows toward a ballast tank;
a flow rate adjustment unit for adjusting a flow rate of the line through which the ballast water flows; and
a flow rate control unit for controlling the flow rate adjustment unit, wherein
the flow rate control unit, in a situation where a filtering capability of the filter is decreased due to attachment of foreign matter on the filter, controls the flow rate adjustment unit so as to increase the pressure on a secondary side of the filter by decreasing the flow rate of the ballast water that has been filtered by the filter, and
the filter is subjected to backwash, with the pressure on the secondary side of the filter having been increased.

2. The ballast water treatment device according to claim 1, further comprising a backwash water spray nozzle configured to spray backwash water toward a surface on the secondary side of the filter, wherein
the flow rate control unit performs the spraying of the backwash water using the backwash water spray nozzle, with the pressure on the secondary side of the filter having been increased.

3. The ballast water treatment device according to claim 1, wherein
the situation where the filtering capability of the filter is decreased is a situation where a differential pressure between the primary side and the secondary side of the filter is equal to or greater than a reference differential pressure,
the ballast water treatment device further includes a differential pressure detection unit for detecting the differential pressure between the primary side and the secondary side of the filter, and
the flow rate control unit, when the differential pressure detected by the differential pressure detection unit has become equal to or greater than the reference differential pressure, controls the flow rate adjustment unit so as to increase the pressure on the secondary side of the filter by decreasing the flow rate of the ballast water that has been filtered by the filter.

4. The ballast water treatment device according to claim 1, wherein
the situation where the filtering capability of the filter is decreased is a situation where a filtering time of the filter has become equal to or greater than a reference time,
the ballast water treatment device further includes a filtering time measurement unit for measuring the filtering time of the filter, and
the flow rate control unit, when the filtering time measured by the filtering time measurement unit has become equal to or greater than the reference time, controls the flow rate adjustment unit so as to increase the pressure on the secondary side of the filter by decreasing the flow rate of the ballast water that has been filtered by the filter.

5. The ballast water treatment device according to claim 1, further comprising a secondary-side pressure sensor that detects the pressure on the secondary side of the filter, wherein
the flow rate control unit, when the pressure on the secondary side of the filter detected by the secondary-side pressure sensor is equal to or greater than a set upper-limit pressure value, controls the flow rate adjustment unit so as to decrease the ballast water introduced from the introduction line to the primary side of the filter.

6. The ballast water treatment device according to claim 5, wherein the flow rate control unit, when the flow rate adjustment unit is controlled so as to decrease the ballast water introduced from the introduction line to the primary side of the filter, controls the flow rate adjustment unit so as to maintain the flow rate of the ballast water that has been filtered by the filter.

7. A method for treating ballast water by filtering the ballast water using a filter and making the ballast water filtered by the filter flow toward a ballast tank, the method comprising:
in a situation where a filtering capability of the filter is decreased due to attachment of foreign matter on the filter, increasing a pressure on a secondary side of the filter by decreasing a flow rate of the ballast water that has been filtered by the filter; and
subjecting the filter to backwash, with the pressure on the secondary side of the filter having been increased.
